(19) United States
(12) Patent Application Publication
(10) Pub. No.: US 2008/0301896 A1
(43) Pub. Date: Dec. 11, 2008

(54) CONNECTING STRUCTURE OF A RESILIENT SUPPORT MEMBER AND A STRIP OF WIPER RUBBER OF A WINDSHIELD WIPER

(76) Inventor: Qing-Huai SHEN, Xiamen (CN)

Correspondence Address: Dr. BANGER SHIA, 102 Lindencrest Ct., Sugar Land, TX, 77479-5201, US

(21) Appl. No.: 12/134,912

(22) Filed: Jun. 6, 2008

(30) Foreign Application Priority Data
Jun. 7, 2007 (CN) 200710009077.5
Aug. 22, 2007 (CN) 200720008041.0

(51) Int. Cl. B60S 1/40

(52) U.S. Cl. 15/250.32

(57) ABSTRACT

The present invention discloses a connecting structure of a resilient support member and a strip of wiper rubber of a windshield wiper. The wiper rubber has a pair of fixing grooves longitudinally passing through the wiper rubber at opposite sides thereof and a T-shaped member at an upper end thereof. A connecting plate is provided between the resilient support member and the wiper rubber to connect the resilient support member and the wiper rubber together. The connecting plate includes a lower C-shaped groove with the gap of the lower C-shaped groove facing down for connection of the T-shaped member of the wiper rubber and an upper connecting groove for insertion of the resilient support member. The action force from the resilient support member directly applies to the hard connecting plate, not to the soft wiper rubber. This design decreases the deformation of the resilient support member and improves the stability of the windshield wiper in use.

### BACKGROUND OF THE INVENTION

1. Field of the Invention

The present invention relates to a connecting structure of a resilient support member and a strip of wiper rubber of a windshield wiper.

2. Description of the Related Art

A windshield wiper disposed in front of an automobile windshield is used to scrape rainwater or dust from a windshield so that a driver can have clear eyesight. As shown in FIGS. 1 & 2, a conventional windshield wiper comprises a strip of wiper rubber 1, a pair of fixing grooves 11 longitudinally passing through the wiper rubber 1 at both sides respectively, a pair of resilient support members 2 inserting into the fixing grooves 11. The resilient support member 2 is made of metallic material having a certain resilience and strength to support the wiper rubber 1 so that the wiper rubber 1 is able to tightly attached to the windshield. After the resilient support member 2 and the wiper rubber 1 are assembled, both ends of the windshield wiper pass through fixing members 6 and are wedded or riveted to fixing buckles 4. An air guiding device 3 is provided on the resilient support members 21. A connecting device 5 is provided on a center portion of the windshield wiper.

The wiper rubber 1 is a soft object having resilience to deform. The resilient support member 2 is made of hard material, which is contact with the wiper rubber 1 directly and provides action force on the wiper rubber 1 directly. When the windshield wiper is in use, the resilient support member 2 and the wiper rubber 1 compress with each other, which is easy to cause the resilient support member 2 to twist and to have malposition. The pressing force from the resilient support member 2 is unable to apply to the wiper rubber 1 evenly, which lowers the transverse stability of the windshield wiper in use. This causes the windshield wiper to tremble. Furthermore, the two resilient support members 2 are longitudinally connected to the both sides of the wiper rubber 1. There is no support in the middle portion of the wiper rubber 1, which affects the scraping function of the windshield wiper.

### SUMMARY OF THE INVENTION

The purpose of the present invention is to provide a connecting structure of a resilient support member and a strip of wiper rubber of a windshield wiper to improve the trembling of the windshield wiper in use and to facilitate the wiper rubber to attach to a windshield tightly.

To achieve the purpose of the present invention, there is provided a connecting structure of a resilient support member and a strip of wiper rubber of a windshield wiper, the wiper rubber having a pair of fixing grooves longitudinally passing through the wiper rubber at opposite sides thereof and a T-shaped member at an upper end thereof, characterized by: a connecting plate being provided between the resilient support member and the wiper rubber to connect the resilient support member and the wiper rubber together, the connecting plate comprising a lower C-shaped groove with the gap of the lower C-shaped groove facing down, and an upper connecting groove for insertion of the resilient support member,

Preferably, the upper connecting groove is a C-shaped groove with the gap of the C-shaped groove facing up for insertion of the resilient support member.

Alternatively, the upper connecting groove is a closed groove for insertion of the resilient support member.

Alternatively, the upper connecting groove is a pair of recesses facing outside for insertion of a pair of resilient support members.

It is one advantage of the present invention to provide a connecting structure of a resilient support member and a strip of wiper rubber of a windshield wiper, which enhances transversally scraping stability when the windshield wiper in use.

It is another advantage of the present invention to provide a connecting structure of a resilient support member and a strip of wiper rubber of a windshield wiper, which decreases the trembling when the windshield wiper in use.

### BRIEF DESCRIPTION OF THE DRAWINGS

FIG. 1 is a perspective view of a conventional windshield wiper;

FIG. 2 is partial perspective view showing the connection of a strip of wiper rubber and a resilient support member of the conventional windshield wiper;

FIG. 3 is a perspective view of a first preferred embodiment of the present invention;

FIG. 4 is a perspective view showing a connecting plate of the first preferred embodiment of the present invention;

FIG. 5 is perspective view showing the connection of a strip of wiper rubber, a resilient support member and the connecting plate of the first preferred embodiment of the present invention;

FIG. 6 is a perspective view showing the connecting plate of a second preferred embodiment of the present invention;

FIG. 7 is a perspective view showing the connecting plate of a third preferred embodiment of the present invention; and

FIG. 8 is perspective view showing the connection of the wiper rubber, the resilient support member and the connecting plate of the third preferred embodiment of the present invention.

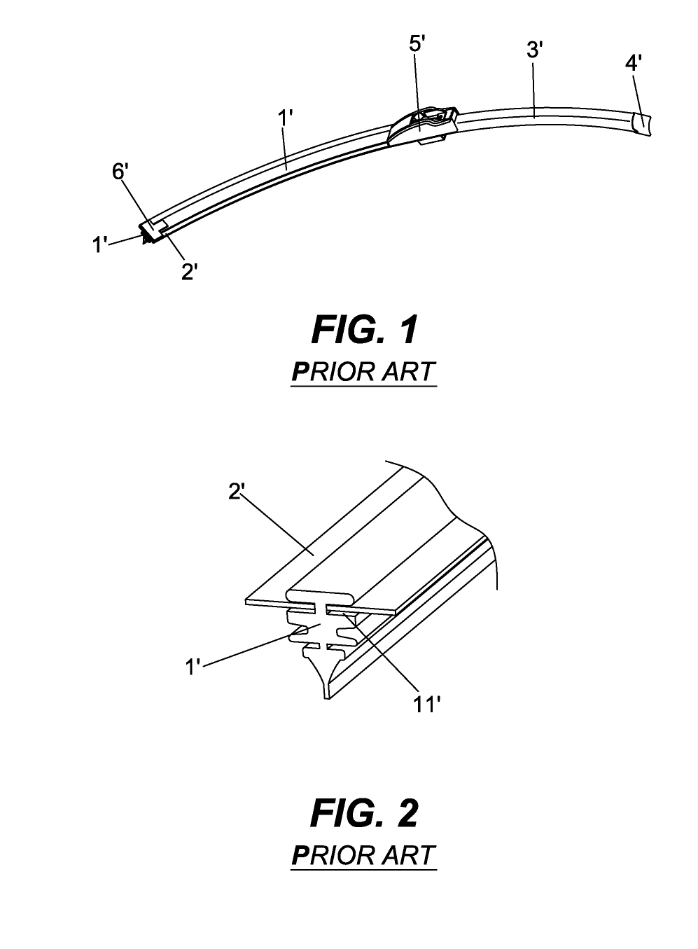

### DETAILED DESCRIPTION OF THE INVENTION

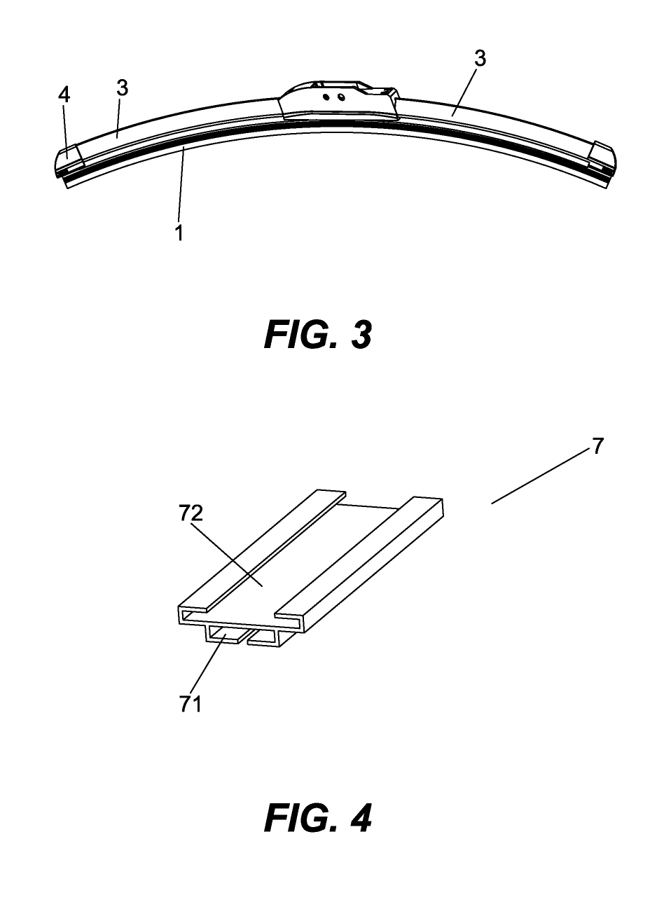

As shown in FIG. 3, a windshield wiper in accordance with a first preferred embodiment of the present invention comprises a strip of wiper rubber 1, a resilient support member 2 and a connecting plate 7 to connect the wiper rubber 1 and the resilient support member 2 together.

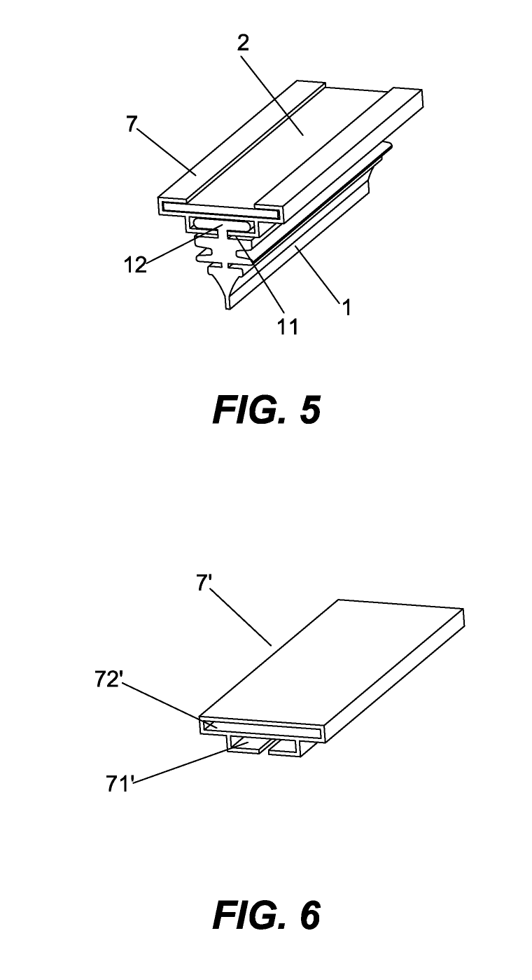

As shown in FIG. 5, the wiper rubber 1 has a pair of fixing grooves 11 longitudinally passing through the wiper rubber 1 at both sides respectively and a T-shaped member 12 at an upper end thereof.

The resilient support member 2 is a plank having a certain resilience and strength.

As shown in FIG. 4, the connecting plate 7 is made of plastics and has the same length as the wiper rubber 1 and the resilient support member 2. The connecting plate 7 comprises a lower C-shaped groove 71 and an upper connecting groove. The upper connecting groove is a C-shaped groove 72. The gap of the lower C-shaped groove 71 faces down, and the gap of the upper C-shaped groove 72 faces up.

To assemble the present invention, the resilient support member 2 is inserted into the upper C-shaped groove 72, and the T-shaped member 12 of the wiper rubber 1 is inserted into and engages with the lower C-shaped groove 71 of the connecting plate 7. The windshield wiper further comprises an air guiding device 3, fixing buckles 4 at both ends and a connecting device 5 at a central portion which have the same assembled way and structures as the prior art and are not described hereinafter.

The connection of the wiper rubber 1, the resilient support member 2, and the connecting plate 7 is in a simple insertion way without passing through fixing members and welding/riveting the resilient support members together. This decreases the procedures of production, and only requires a single resilient support member 2. The connecting plate 7 has more hardness. The resilient support member 2 is contact with the connecting plate 7 only and clamped tightly by the upper C-shaped groove 72 of the connecting plate 7. This enhances the transversal rigidness and improves the stability of the windshield wiper in use, preventing the resilient support member 2 from malposition. The wiper rubber 1 is clamped tightly by the lower C-shaped groove 71 of the connecting plate 7, which also improves the stability of the windshield wiper in use.

FIG. 6 shows a second preferred embodiment of the present invention. This embodiment is substantially similar to the aforesaid first embodiment with the exceptions described hereinafter. According to this embodiment, the connecting plate 7 has the lower C-shaped groove 71 and the upper connecting groove. The upper connecting groove is a closed groove 72 for insertion of the resilient support member 2.

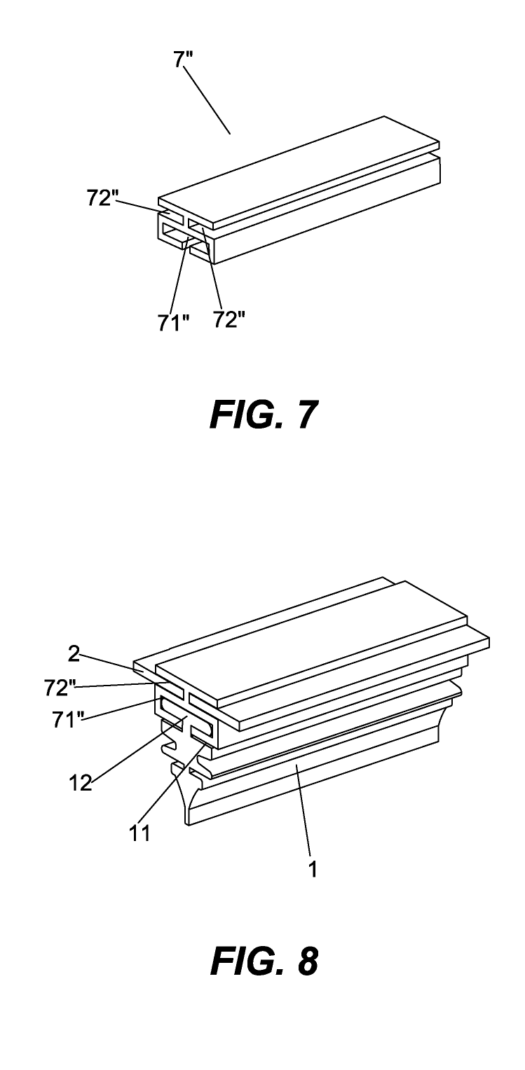

FIG. 7 shows a third preferred embodiment of the present invention. This embodiment is substantially similar to the aforesaid first and second embodiments with the exceptions described hereinafter. According to this embodiment, the connecting plate 7 has the lower C-shaped groove 71 and the upper connecting groove. The upper connecting groove is a pair of recesses 72 facing outside at both upper sides respectively. As shown in FIG. 8, the wiper rubber 1 is inserted into the lower C-shaped groove 71. There are two resilient support members 2 in this embodiment. The pair of the resilient support members 2 are inserted into the recesses 72. The thickness of the resilient support member 2 is the same as that of the recess 72 so that the resilient support member engages with the recess 72 tightly.

Although the present invention has been shown and described with respect to the preferred embodiments, it will be understood by those skilled in the art that various changes and modifications may be made without departing from the spirit and scope of the invention as defined in the following claims.

What is claimed is:

1. A connecting structure of a resilient support member and a strip of wiper rubber of a windshield wiper, the wiper rubber having a pair of fixing grooves longitudinally passing through the wiper rubber at opposite sides thereof and a T-shaped member at an upper end thereof, characterized by: a connecting plate being provided between the resilient support member and the wiper rubber to connect the resilient support member and the wiper rubber together, the connecting plate comprising a lower C-shaped groove with the gap of the lower C-shaped groove facing down and an upper connecting groove for insertion of the resilient support member,

2. The connecting structure of a resilient support member and a strip of wiper rubber of a windshield wiper as claimed in claim 1, wherein the upper connecting groove is a C-shaped groove with the gap of the C-shaped groove facing up for insertion of the resilient support member.

3. The connecting structure of a resilient support member and a strip of wiper rubber of a windshield wiper as claimed in claim 1, wherein the upper connecting groove is a closed groove for insertion of the resilient support member.

4. The connecting structure of a resilient support member and a strip of wiper rubber of a windshield wiper as claimed in claim 1, wherein the upper connecting groove is a pair of recesses facing outside for insertion of a pair of resilient support members.
